(19) United States
(12) Patent Application Publication
(10) Pub. No.: US 2026/0267843 A1
(43) Pub. Date: Sep. 10, 2026

(54) METHOD AND APPARATUS OF MANAGING EMBEDDING TABLE, ELECTRONIC DEVICE, STORAGE MEDIUM, SYSTEM AND COMPUTER PROGRAM PRODUCT

(71) Applicant: Samsung Electronics Co., Ltd., Suwon-si (KR)

(72) Inventors: Hao WU, Xi'an (CN); Shuyang WANG, Xi'an (CN); Yuqi ZHANG, Xi'an (CN)

(73) Assignee: Samsung Electronics Co., Ltd., Suwon-si (KR)

(21) Appl. No.: 19/173,086

(22) Filed: Apr. 8, 2025

(30) Foreign Application Priority Data
Mar. 7, 2025 (CN) 202510271994.9

(51) Int. Cl. G06F 16/22

(52) U.S. Cl. CPC G06F 16/2237

(57) ABSTRACT

A method and apparatus of managing an embedding table, an electric device, a storage medium, a system and a computer program product, wherein the method includes: acquiring input data; looking up embedding vectors corresponding to the input data from an embedding table of a model stored in a memory semantic solid state drive (MS SSD); transferring the embedding vectors from the MS SSD to a graphics processing unit (GPU); and instructing the GPU to transfer updated embedding vectors to the MS SSD for updating the embedding table, the updated embedding vectors acquired by training the model based on the embedding vectors transferred to the GPU.

### CROSS-REFERENCE TO RELATED APPLICATION

This application claims priority under 35 U.S.C. § 119 to Chinese Patent Application No. 202510271994.9, filed on Mar. 7, 2025, in the State Intellectual Property Office of the P.R.C., the contents of which is incorporated herein by reference in its entirety.

### TECHNICAL FIELD

The present disclosures relate to a storage field, and specifically to a method and apparatus for managing an embedding table, an electric device, a storage medium, a system and a computer program product.

### BACKGROUND

A deep learning recommendation model (DLRM) is a personalized recommendation model based on a neural network. Training a deep learning recommendation model may be mainly divided into two parts of looking up an embedding table and training a multilayer perceptron. The embedding table is usually very large and may occupy hundreds of gigabytes or even terabytes of memory, and the related technology mainly focuses on how to store the embedding table.

Whether using a graphics processing unit (GPU), a central processing unit (CPU) alone, or a combination of the GPU and the CPU for storing the embedding table and training the multilayer perceptron, balancing the cost, communication overhead, data transmission speed, model training speed, memory expansion, cache hit rate, and/or other problems may be challenging.

### SUMMARY

Some example embodiments of the present disclosures provide a method and apparatus of managing an embedding table, an electric device, a storage medium, a system and/or a computer program product, to at least solve the above technical problems and/or other technical problems not mentioned above.

According to some example embodiments of the present disclosures, there is provided a method of managing an embedding table by a processor, the method comprising: acquiring input data; looking up embedding vectors corresponding to the input data from an embedding table of a model stored in a memory semantic solid state drive (MS SSD); transferring the embedding vectors from the MS SSD to a graphics processing unit (GPU); and instructing the GPU to transfer updated embedding vectors to the MS SSD for updating the embedding table, the updated embedding vectors acquired by training the model based on the embedding vectors transferred to the GPU.

According to some example embodiments, the MS SSD includes a non-volatile memory and a dynamic random-access memory (DRAM) and the non-volatile memory is configured to store the embedding table of the model.

According to some example embodiments, the looking up of the embedding vectors comprises prefetching first embedding vectors corresponding to first input data from the non-volatile memory into the DRAM through a prefetch interface of the MS SSD, wherein the first input data is a plurality of batches of data currently to be processed of the input data; and the transferring of the embedding vectors from the MS SSD to the GPU comprises transferring the first embedding vectors corresponding to the first input data from the DRAM to the GPU.

According to some example embodiments, the transferring of the embedding vectors from the MS SSD to the GPU further comprises prefetching second embedding vectors corresponding to second input data and not saved in the GPU from the DRAM into the GPU, in response to processing a current batch of data of the input data, wherein the second input data is a first batch of data to be processed; and the looking up of the embedding vectors further comprises prefetching third embedding vectors corresponding to third input data and not saved in the GPU from the NAND into the DRAM, wherein the third input data is a second batch of data to be processed of the input data.

According to some example embodiments, the method further includes: recording information about the embedding vectors saved in the GPU by a prefetch management queue; and updating information about the prefetched second embedding vectors corresponding to the second input data to the information recorded by the prefetch management queue.

According to some example embodiments, the training the model based on the embedding vectors by the GPU to obtain the updated embedding vectors includes: training the model based on the second embedding vectors corresponding to the current batch of data of the input data by the GPU to obtain the updated embedding vectors; and deleting information about embedding vectors that are not required or advantageous for the first input data from the GPU.

According to some example embodiments, the deleting the information about the embedding vectors that are not required for the first input data from the GPU includes: checking embedding vectors corresponding to each batch of data of the first input data and counting a frequency of occurrence of each embedding vector among all the embedding vectors corresponding to each batch of data of the first input data; in response to the training of the model having been completed based on the second embedding vectors corresponding to the current batch of data of the input data, subtracting a frequency of occurrence of each embedding vector corresponding to the current batch of data from the counted frequency of occurrence of each embedding vector, correspondingly; and deleting, from the GPU, an embedding vector whose frequency of occurrence is subtracted to 0.

According to some example embodiments, the deleting, from the GPU, the embedding vector whose frequency of occurrence is subtracted to 0 includes: deleting information about the embedding vector whose frequency of occurrence is subtracted to 0 from information recorded by a prefetch management queue.

According to some example embodiments, the first input data is a batch n+1 to n+l of data currently to be processed of the input data, n being a current batch, and a size of l being a size of a remaining video memory of the GPU divided by a size of all embedding vectors corresponding to one batch of data.

According to some example embodiments, the method further includes: writing a collection of frequent access sets centrally into a region of a non-volatile memory of the MS SSD, wherein the collection of frequent access sets is a collection of embedding vector sets that are accessed more frequently than a first value.

According to some example embodiments, the writing the collection of frequent access sets centrally into the region of the non-volatile memory of the MS SSD includes: counting a frequency of occurrence of each embedding vector set among all embedding vectors corresponding to each data of first input data, and using a collection of longest embedding vector sets whose frequency of occurrence are greater than a second value as the collection of frequent access sets, wherein the first input data is a plurality of data in the input data; and merging and writing all embedding vectors corresponding to the collection of frequent access sets into the region of the non-volatile memory, wherein the region of the non-volatile memory includes a page in the non-volatile memory.

According to some example embodiments, the method further includes: recording, in a mapping table, a mapping relationship between indexes of all the embedding vectors corresponding to the collection of frequent access sets and the indexes after the merging and writing.

According to some example embodiments, the counting the frequency of occurrence of each embedding vector set among all embedding vectors corresponding to each data of the first input data, and the using the collection of longest embedding vector sets whose frequency of occurrence are greater than the second value as the collection of frequent access sets includes: setting k to be an integer greater than or equal to 1; counting a frequency of occurrence of each pending embedding vector set among all embedding vectors corresponding to each data of the first input data, and using a collection of pending embedding vector sets whose frequency of occurrence are greater than the second value as a collection Lₖ of pending frequent access sets, wherein the pending embedding vector set contains information corresponding to k embedding vectors; combining pending embedding vector sets having k−1 common embedding vectors among the pending embedding vector sets of Lₖ by pairs, to obtain at least one updated pending embedding vector set; determining whether a condition is satisfied, the condition being that k is equal to a maximum number of embedding vectors that can be stored on one page of the non-volatile memory, or that at least one updated pending embedding vector set from each embedding vector set corresponding to the first input data cannot be found; using the collection Lₖ of the pending frequent access sets as the collection of frequent access sets in response to the condition being satisfied; and assigning k to k+1 in response to the condition not being satisfied and repeating the counting, the combining, and the determining.

According some example embodiments of the present disclosures, there is provided an apparatus configured to manage an embedding table, the apparatus comprising: a data acquisition unit configured to acquire input data; an embedding lookup unit configured to look up embedding vectors corresponding to the input data from an embedding table of a model stored in a memory semantic solid state drive (MS SSD), and transfer the embedding vectors from the MS SSD to a graphics processing unit (GPU); an embedding update unit configured to train the model based on the embedding vectors by the GPU to obtain updated embedding vectors; and an embedding write unit configured to transfer the updated embedding vectors from the GPU to the MS SSD for updating the embedding table.

According to some example embodiments, the MS SSD includes a non-volatile memory and a dynamic random-access memory (DRAM) and the non-volatile memory is configured to store the embedding table of the model.

According to some example embodiments, the embedding lookup unit is configured to: prefetch first embedding vectors corresponding to first input data from the non-volatile memory into the DRAM through a prefetch interface of the MS SSD, wherein the first input data is a plurality of batches of data currently to be processed of the input data; and transfer the first embedding vectors corresponding to the first input data from the DRAM to the GPU.

According to some example embodiments, the embedding lookup unit is further configured to: prefetch, from the DRAM into the GPU, second embedding vectors corresponding to second input data and not saved in the GPU, in response to processing a current batch of data of the input data, wherein the second input data is a first batch of data to be processed of the input data; and prefetch, from the non-volatile memory into the DRAM, third embedding vectors corresponding to third input data and not saved in the GPU, wherein the third input data is a second batch of data to be processed of the input data.

According to some example embodiments, the apparatus further includes an embedding prefetch unit configured to: record information about the embedding vectors saved in the GPU by a prefetch management queue; and update information about the prefetched second embedding vectors corresponding to the second input data to the information recorded by the prefetch management queue.

According to some example embodiments, the embedding update unit is configured to: train the model based on the second embedding vectors corresponding to the current batch of data of the input data by the GPU to obtain the updated embedding vectors; and delete information about embedding vectors that are not required for the first input data from the GPU.

According to some example embodiments, the embedding update unit is configured to: check embedding vectors corresponding to each batch of data of the first input data and count a frequency of occurrence of each embedding vector among all the embedding vectors corresponding to each batch of data of the first input data; in response to the training of the model having been completed based on the second embedding vectors corresponding to the current batch of data of the input data, subtract a frequency of occurrence of each embedding vector corresponding to the current batch of data from the counted frequency of occurrence of each embedding vector, correspondingly; and delete, from the GPU, an embedding vector whose frequency of occurrence is subtracted to 0.

According to some example embodiments, the embedding update unit is configured to: delete information about the embedding vector whose frequency of occurrence is subtracted to 0 from information recorded by a prefetch management queue.

According to some example embodiments, the first input data is a batch n+1 to n+l of data currently to be processed of the input data, n being a current batch, and a size of l being a size of a remaining video memory of the GPU divided by a size of all embedding vectors corresponding to one batch of data.

According to some example embodiments, the apparatus further includes an embedding merge unit configured to: write a collection of frequent access sets centrally into a region of a non-volatile memory of the MS SSD, wherein the collection of frequent access sets is a collection of embedding vector sets that are accessed more frequently than a first value.

According to some example embodiments, the embedding merge unit is configured to: count a frequency of occurrence of each embedding vector set among all embedding vectors corresponding to each data of first input data, and use a collection of longest embedding vector sets whose frequency of occurrence are greater than a second value as the collection of frequent access sets, wherein the first input data is a plurality of data in the input data; and merge and write all embedding vectors corresponding to the collection of frequent access sets into the region of the non-volatile memory, wherein the region of the non-volatile memory includes a page in the non-volatile memory.

According to some example embodiments, the apparatus further includes an index mapping unit configured to: record, in a mapping table, a mapping relationship between indexes of all the embedding vectors corresponding to the collection of frequent access sets and the indexes after the merging and writing.

According to some example embodiments, the embedding merge unit is configured to: set k to be an integer greater than or equal to 1; count a frequency of occurrence of each pending embedding vector set among all embedding vectors corresponding to each data of the first input data, and use a collection of pending embedding vector sets whose frequency of occurrence are greater than the second value as a collection Lₖ of pending frequent access sets, wherein the pending embedding vector set contains information corresponding to k embedding vectors; combine pending embedding vector sets having k−1 common embedding vectors among the pending embedding vector sets of Lₖ by pairs, to obtain at least one updated pending embedding vector set; determine whether a condition is satisfied, the condition being that k is equal to a maximum number of embedding vectors that can be stored on one page of the non-volatile memory, or that at least one updated pending embedding vector set from each embedding vector set corresponding to the first input data cannot be found; use the collection Lₖ of the pending frequent access sets as the collection of frequent access sets in response to the condition being satisfied; and assign k to k+1 in response to the condition not being satisfied and repeat the counting, the combining, and the determining.

According to some example embodiments of the present disclosures, there is further provided an electronic device. The electronic device comprising: at least one processor; and at least one memory configured to store computer-executable instructions, the computer-executable instructions, in response to being run by the at least one processor, is configured to cause the at least one processor to perform the method of managing the embedding table according to any of the example embodiments as described above.

According to some example embodiments of the present disclosures, there is further provided a non-transitory computer readable storage medium storing instructions, wherein the instructions, in response to being run by at least one processor, is configured to cause the at least one processor to perform the method of managing the embedding table according to any of the example embodiments as described above.

According to some example embodiments of the present disclosures, there is further provided a system including at least one computing apparatus and at least one storage apparatus configured to store instructions, wherein the instructions, in response to being run by the at least one computing apparatus, is configured to cause the at least one computing apparatus to perform the method of managing the embedding table according to any of the example embodiments as described above.

According to some example embodiments of the present disclosures, there is further provided a computer program product including a computer program/instruction, wherein the computer program/instruction, in response to being run by a processor, implements the method of managing the embedding table according to any of the example embodiments as described above.

The technical solutions provided by the present disclosures may have at least the following beneficial effects:

The method, apparatus, electronic device, storage medium, system, and/or computer program product for managing an embedding table according to some example embodiments of the present disclosures may use the MS SSD for storing an embedding table, realizing a reduction in cost expenditure while being able to provide a larger storage capacity, and during a training process of a model, embedding table lookup is performed in the MS SSD, and updated embedding vectors are stored in the MS SSD to update the embedding table stored in the MS SSD, thus low-latency, high-bandwidth, and high-input-output performance may be achieved through dual interfaces of the MS SSD.

In some example embodiments, prefetching management is realized through the prefetch interface of the MS SSD, which may prefetch the required or advantageous data from the MS SSD to the DRAM of the MS SSD in advance, realizing a high cache hit rate and high bandwidth reading at the same time.

In some example embodiments, since the embedding vectors required or advantageous for successive training batches may be duplicated, in the process of prefetching the embedding vectors from the DRAM to the GPU each time, embedding vectors that are to be prefetched are filtered, and only embedding vectors that are not saved in the CPU are prefetched, which may reduce the amount of data transmission between the MS SSD and the GPU, and thus reduce the bottleneck and burden of data transmission, and free up the memory of the GPU.

In some example embodiments, a queue may be used to manage information (e.g., indexes, etc.) of embedding vectors required or advantageous for successive batches of input data to easily and efficiently reduce the number of embedding vectors to be transferred between the MS SSD and the GPU, thus solving the bottleneck of data transmission.

In some example embodiments, when using the current batch of input data for model training, the embedding vectors that are not required or advantageous for the subsequent batch of input data may be deleted from the GPU, which may free up the memory space of the GPU.

In some example embodiments, since a page is a basic storage unit of the NAND (NOT AND Flash, which is a non-volatile memory chip in which a number of NAND gates form a logical architecture), a collection of frequently accessed embedding vector sets are written centrally to a same page of the NAND, which enables embedding offloading to increase spatial locality and reduce read amplification, and the prefetching and storing of more required or advantageous embedding vectors may be realized with the same DRAM capacity, which improves the caching efficiency and increases the throughput of model training.

In some example embodiments, by optimizing the offloading and prefetching of the embedding table between the GPU and the MS SSD, a larger effective transmission throughput between the GPU and the MS SSD may be achieved.

### BRIEF DESCRIPTION OF THE DRAWINGS

The accompanying drawings herein, which are incorporated into and form a part of the specification, illustrate some example embodiments consistent with the present inventive concepts or the present disclosures and are used in conjunction with the specification to explain the principles of the present inventive concepts or the present disclosure and do not constitute an undue limitation of the present inventive concepts or the present disclosure.

FIG. 1 illustrates an example structure schematic diagram of a deep learning recommendation model;

FIG. 2 illustrates an example structure schematic diagram of an embedding table;

FIG. 3 illustrates an example statistical graph showing that an embedding table has high temporal locality;

FIG. 4 illustrates an example diagram of vectors in a frequent vector set being required simultaneously in different inputs;

FIG. 5 illustrates an example schematic diagram of applying a GPU or CPU to a training process for a deep learning recommendation model;

FIG. 6 illustrates an example schematic diagram of applying a GPU in combination with a CPU to a training process for a deep learning recommendation model;

FIG. 7 illustrates a flowchart of a method for managing an embedding table according to some example embodiments of the present disclosures;

FIG. 8 illustrates a schematic diagram of a structure and an operation of an MS SSD used according to some example embodiments of the present disclosures;

FIGS. 9A-9B illustrates a schematic comparison diagram between example operations of a NVMe SSD and an MS SSD according to some example embodiments of the present disclosures, respectively, in a training process of a deep learning recommendation model;

FIG. 10 illustrates a schematic diagram of comparison between an example of prefetching embedding vectors and a prefetch management scheme according to some example embodiments of the present disclosures;

FIG. 11 illustrates a schematic diagram of an operation flow for updating a prefetch state according to some example embodiments of the present disclosures;

FIG. 12 illustrates an example schematic diagram of read amplification due to low spatial locality of an embedding table;

FIG. 13 illustrates a schematic diagram of an operation of embedding offloading according to some example embodiments of the present disclosures;

FIG. 14 illustrates a schematic diagram of optimizing read amplification by embedding offloading according to some example embodiments of the present disclosures;

FIG. 15 illustrates a schematic diagram of an algorithmic flow for counting a frequent access set by index according to some example embodiments of the present disclosures;

FIG. 16 illustrates a schematic diagram of an operation combining embedding offloading and prefetch management according to some example embodiments of the present disclosures;

FIG. 17 illustrates a block diagram of an apparatus of managing an embedding table according to some example embodiments of the present disclosures; and

FIG. 18 is a block diagram of an electronic device according to some example embodiments of the present disclosures.

### DETAILED DESCRIPTION

In order to enable a person of ordinary skill in the art to better understand technical solutions of some example embodiments of the present disclosures, the technical solutions according to some example embodiments of the present disclosures will be described clearly and completely in the following, in conjunction with the accompanying drawings.

It is noted that terms “first”, “second” and the like in the specification and claims and the above accompanying drawings are used for distinguishing similar objects, and need not to be used for describing a particular order or sequence. It should be understood that data so used may be interchanged, where appropriate, so that some example embodiments of the present disclosures described herein may be implemented in an order other than those illustrated or described herein. The example embodiments described in the following example embodiments do not represent all example embodiments consistent with the present disclosures. Rather, they are only examples of apparatuses and methods consistent with some example embodiments of the present disclosures as detailed in the appended claims. In the present disclosures, a singular form such as “a”, “an” or “the” may also refer to a plural form.

It is noted herein that a phrase “at least one of several items” as it appears according to some example embodiments of the present disclosures is intended to encompass three parallel cases of “any one of the several items”, “a combination of any number of the several items” , and “all of the several items”. For example, “including at least one of A and B” includes the following three parallel cases: (1) including A; (2) including B; and (3) including A and B. Another example is “performing at least one of step 1 and step 2”, which represents the following three parallel cases: (1) performing step one; (2) performing step two; and (3) performing step one and step two.

A deep learning recommendation model may be trained by input data consisting of dense and sparse features. A deep learning recommendation model may include an input module, an embedding table lookup module and a deep learning module.

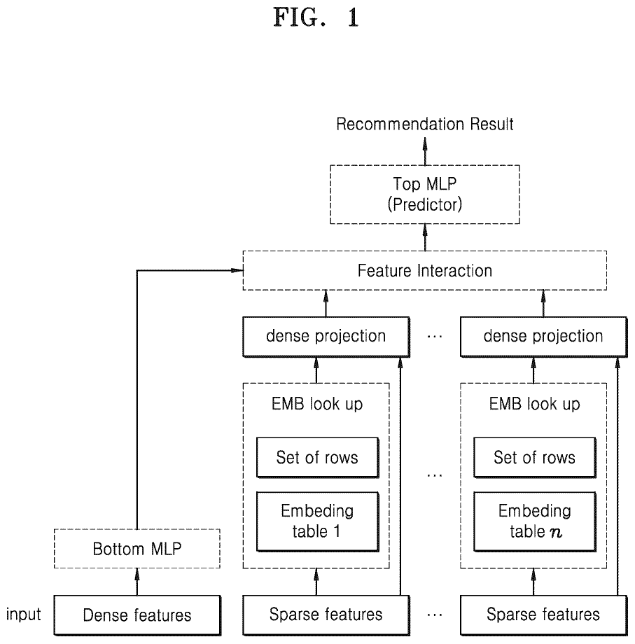

FIG. 1 illustrates an example structure schematic diagram of a deep learning recommendation model.

Referring to FIG. 1, an input part may include dense features and sparse features. The dense features may include continuous data, such as numerical data such as age; and the sparse features may include categorical data, such as data of certain pages preferred by a user in a page list, etc., which are large and sparse.

A deep learning model may capture deep features useful or advantageous for solving a task among the dense features by learning through a multilayer perceptron (MLP) layer (Bottom MLP in FIG. 1) in the deep learning module.

The deep learning model is not, or may not be, suitable for learning from sparse data, so the deep learning recommendation model uses an embedding table (EMB table) to map classification features to dense representations during training.

For the sparse features, in the training process of the deep learning recommendation model, embedding table lookup (EMB lookup) may be used to look up some rows (Set of rows in FIG. 1) in each embedding table, and dense projection corresponding to the sparse features may be calculated from these rows.

After the dense projection of the sparse features and the dense features are aggregated, a multilayer perceptron layer (Top MLP in FIG. 1) for prediction (Predictor) in the deep learning module may be used to capture interactions between different features (Feature Interaction in FIG. 1), and ultimately output recommendation results.

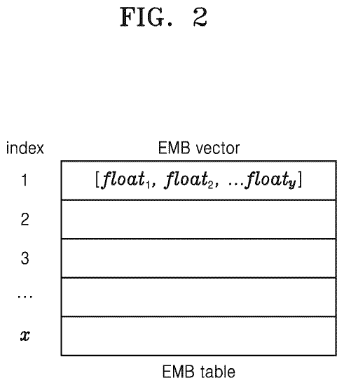

FIG. 2 illustrates an example structure schematic diagram of an embedding table.

Referring to FIG. 2, an embedding table is a matrix of size x×y. Each row may represent a unique embedding vector (EMB vector) composed of floats, which usually may contain 16, 32, or 64 learning features, e.g., how many columns (y) it has. An embedding table may usually contain billions of embedding vectors, such as a billion rows (x), and the embedding vectors are numbered with indexes as illustrated in FIG. 2, e.g., the rows are numbered, and these vectors represent different classification features. The embedding table would occupy hundreds of gigabytes or even terabytes of memory.

The embedding table lookup process means that, for the sparse features, some embedding vectors required, or alternatively advantageous, for an input are read from the entire embedding table using index(es) provided by the input. The embedding vectors required, or alternatively advantageous, for the input are stored discretely in different parts of a hard disk, and are read with a high degree of discretization, which lead to low spatial locality. For example, low spatial locality may mean or indicate that accesses to the embedding table are spread out and not clustered together. For example, low spatial locality may indicate that when a part of the embedding table is accessed, the next or subsequent access may likely be in a different part rather than the same part previously accessed.

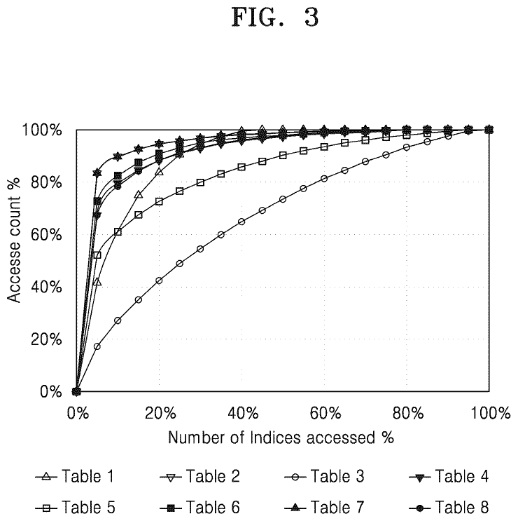

FIG. 3 illustrates an example statistical graph showing that an embedding table has high temporal locality.

Referring to FIG. 3, it may be seen that for embedding tables 1 to 8 (Tables 1~8) used in the study, almost 80% of accesses to embedding vectors (access count %) are concentrated in frequently accessed embedding vectors (number of indices accessed %) in 10% to 40% of the entire embedding table, in looking up the embedding tables 1 to 8, respectively. Thus, the embedding table has high temporal locality. This property is because embedding vectors required, or alternatively advantageous, for an input are related to recommended categories, and there may be similarity in categories of some users, thus, there are many frequent vector sets, and vectors in the frequent vector sets are usually required or advantageous simultaneously in different inputs. For example, temporal locality may mean or suggest that if a particular data item is accessed, that particular data item may likely be accessed again in the future (e.g., in subsequent accesses). For example, as illustrated in FIG. 3, high temporal locality may mean, indicate, or suggest, that same entries in the embedding table are accessed repeatedly (e.g., over short periods of time).

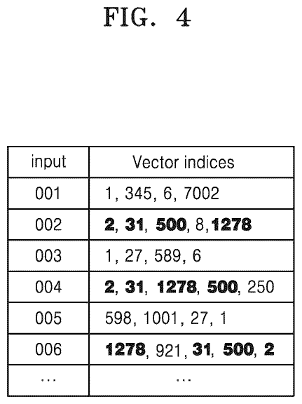

FIG. 4 illustrates an example diagram of vectors in a frequent vector set being required simultaneously in different inputs.

Referring to FIG. 4, for a plurality of inputs in a prediction task, e.g., inputs 001 to 006, etc., denoted by a number, indexes (e.g., indices) of embedding vectors required or advantageous for the input 001 may be [1, 345, 6, 7002], indexes of embedding vectors required or advantageous for the input 002 may be [2, 31, 500, 8, 1278], indexes of embedding vectors required or advantageous for the input 003 may be [1, 27, 589, 6], indexes of embedding vectors required or advantageous for the input 004 may be [2, 31, 1278, 500,250], indexes of embedding vectors required or advantageous for the input 005 may be [598, 1001, 27, 1], and indexes of embedding vectors required or advantageous for the input 006 may be [1278, 921, 31, 500, 2] . It may be seen that the vectors corresponding to the indexes [2, 31, 500, 1278] in FIG. 4 are required or may likely be needed simultaneously in several different inputs (e.g., the input 002, the input 004, the input 006, etc.), and the vectors corresponding to the indexes [2, 31, 500, 1278] may be regarded as a frequent vector set for this prediction task.

In summary, the embedding table has low spatial locality and high temporal locality.

According to some example embodiments, the process of training a deep learning recommendation system may be divided into two main parts of looking up the embedding table and training the multilayer perceptron (e.g., Top MLP in FIG. 1). The embedding table is usually large or very large and may occupy hundreds of GB (GigaByte) or even TB (TeraByte) of memory, and the related techniques mainly focus on how to store the embedding table, e.g.:
(1)The embedding table may be stored on a video memory of a GPU;
(2)The embedding table may be stored in a memory of a CPU and a model may be trained using the CPU;
(3)The embedding table may be stored in the memory of the CPU and the model may be trained using the GPU.

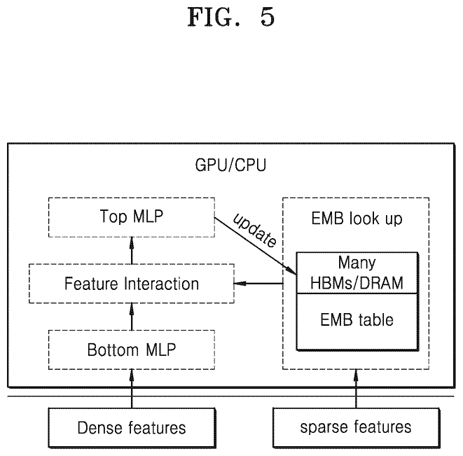

FIG. 5 illustrates an example schematic diagram of applying a GPU or CPU to a training process for a deep learning recommendation model.

Referring to FIG. 5, all model parameters including an embedding table may be stored, for example, in a video memory of a GPU and the GPU may be used to train a multilayer perceptron.

All model parameters including the embedding table may be, or may also be, stored in a memory of a CPU and the CPU may be used to train the multilayer perceptron.

In applying the GPU or the CPU to the training process of the deep learning recommendation model, for the embedding table that maps sparse features to dense representations, the embedding table may be stored mainly in the GPU or the CPU. For example, the storing the embedding table may usually be done using a large amount of High Bandwidth Memory (HBM) or DRAM, and the GPU or CPU may perform embedding table lookup, capturing deep features useful for solving a task among dense features through a multilayer perceptron layer (e.g., Bottom MLP in FIG. 5), performing feature interaction, performing prediction through a multilayer perceptron layer (e.g., Top MLP in FIG. 5), and writing of updated embedding vectors to the embedding table stored in the GPU or CPU, to update the stored embedding table.

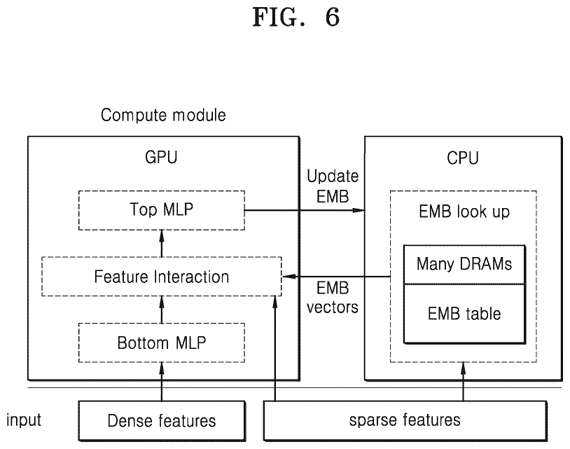

FIG. 6 illustrates an example schematic diagram of applying a GPU in combination with a CPU to a training process for a deep learning recommendation model.

Referring to FIG. 6, an entire embedding table may be stored in a memory (DRAM) of the CPU, and the storing of this embedding table may occupy a large amount of DRAM. A multilayer perceptron may be trained using the GPU. During forward propagation, the CPU may transfer embedding vectors required or advantageous for sparse features, which are embedding vectors corresponding to sparse features required or advantageous for an input, to the GPU. The GPU may calculate dense projection of the sparse features and aggregate them with dense features that have been processed by the multilayer perceptron (e.g., Bottom MLP in FIG. 6) (e.g., the feature interaction) for subsequent training via the multilayer perceptron (e.g., Top MLP in FIG. 6). During backpropagation, the GPU may transfer updated embedding vectors to the memory of the CPU. The GPU may be viewed as a computational module.

In the above three scenarios, there are usually problems such as (1) excessive GPUs may be required or advantageous, resulting in high cost and wasted computational resources, (2) slow or slower training speed and limited or reduced memory expansion of the CPU, and (3) high or higher communication overhead between the CPU and the GPU, resulting in an inefficient training process, for example:
(1)Excessive GPUs required: storing the embedding table on the GPU usually requires tens or even hundreds of GPUs since the embedding table may exceed the maximum memory size of the GPU; and the GPU with rich integrated memory is expensive or extremely expensive. In addition, the model training does not require so many GPUs, which may result in a waste of computational resources.
(2)Slow training speed and limited memory expansion of the CPU: the advantage of CPU-only training is that the DRAM of the CPU is much cheaper and all communication overhead is eliminated; however, the disadvantage of this technique is that computation may become a bottleneck because the multilayer perceptron and second-order interaction may be slower or much slower on the CPU than on the GPU; and the memory expansion of the CPU may be limited due to the impact of hardware.
(3)High communication overhead between the CPU and the GPU: during the training process of the model, the CPU needs to transfer required or advantageous embedding vectors into the GPU, and the GPU needs to transfer updated vectors back to the CPU, and the frequent communication between the CPU and the GPU generates a large transmission overhead.

In order to solve the above problems, some example embodiments of the present disclosures provide a method, apparatus, electronic device, storage medium, system, and computer program product for managing an embedding table, which may use a memory semantic solid state drive (MS SSD) for storing an embedding table, realizing a reduction in cost expenditure while being able to provide a large or larger storage capacity. Additionally, according to some example embodiments, during a training process of a model, embedding table lookup is, or may be, performed in the MS SSD, and updated embedding vectors are stored in the MS SSD to update the embedding table stored in the MS SSD, thus low-latency, high-bandwidth, and high-input-output performance may be achieved through dual interfaces of the MS SSD.

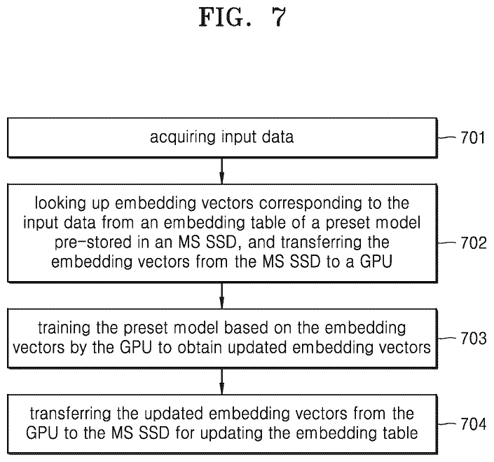

In the following, the method, apparatus, electronic device, storage medium, system, and computer program product for managing an embedding table according to some example embodiments of the present disclosures will be specifically described with reference to FIGS. 7 through 18.

FIG. 7 illustrates a flowchart of a method for managing an embedding table according to some example embodiments of the present disclosures.

Referring to FIG. 7, at operation 701, input data may be acquired.

According to some example embodiments of the present disclosures, a preset model may include various deep learning models, machine learning models, and the like that require or may benefit from learning from discrete features. According to some example embodiments, an input to the preset model may be very diverse, depending on a specific, or alternatively desired task and architecture of the model. Thus, the input data according to some example embodiments of the present disclosures may include, but is not limited to, the following types of data: image data, text data, audio data, time series data, structured data (e.g., tabular data, etc.), graphical and network data, multimodal data (e.g., a combination of multiple types of data, such as a combination of image and text (used in an image description generation task) or a combination of audio and video (used in a sentiment analysis task), etc.).

At operation 702, embedding vectors corresponding to the input data may be looked up from an embedding table of a preset model in an MS SSD, and may be transferred from the MS SSD to a GPU. Alternatively, in some example embodiments, the embedding table of a preset model may be stored or pre-stored in the MS SSD.

According to some example embodiments of the present disclosures, the MS SSD may be used in processes of training, validating, testing, predicting, etc., of the preset model (e.g., a deep learning recommendation model, etc.), to take advantage of the large capacity and high efficiency of the MS SSD. For example, the embedding table of the preset model may be stored in advance in a memory of the MS SSD, the embedding vectors required for, or advantageous for (corresponding to) the input data may be looked up directly in the memory of the MS SSD, and the looked-up embedding vectors may be directly transferred from the memory of the MS SSD to the GPU.

According to some example embodiments of the present disclosures, the MS SSD may include a NAND and a DRAM. In some example embodiments, the embedding table of the preset model is stored in the NAND; the embedding vectors corresponding to first input data may be prefetched from the NAND into the DRAM through a prefetch interface of the MS SSD, wherein the first input data is a preset plurality of batches of data currently to be processed of the input data; the embedding vectors corresponding to the first input data may be transferred or sent from the DRAM to the GPU.

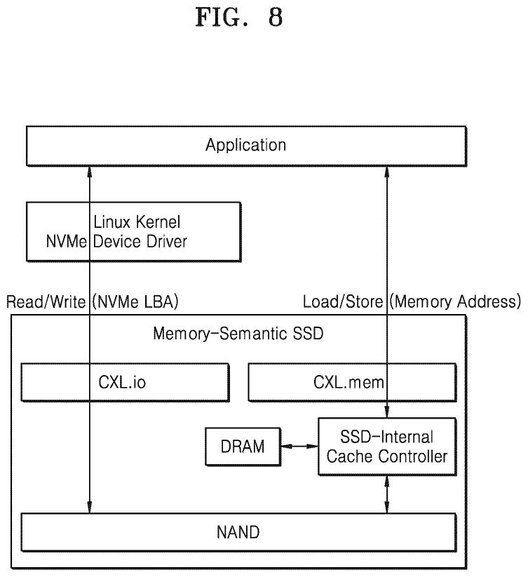

FIG. 8 illustrates a schematic diagram of a structure and an operation of an MS SSD according to some example embodiments of the present disclosures.

Referring to FIG. 8, the MS SSD according to some example embodiments of the present disclosures may also include dual interfaces supporting a CXL. mem protocol (e.g., a protocol of high-speed interconnect technology (Compute Express Link)) and a CXL. io protocol (e.g., another protocol of the high-speed interconnect technology (Compute Express Link)), respectively. According to some example embodiments, an application may use a memory interface supported by the CXL. mem protocol by an SSD-internal cache controller to realize a data load/store process through a memory address, to achieve high or higher input/output performance with low or lower latency. In some example embodiments, the application may also use a Non-Volatile Memory Express (NVMe) Logical Block Address (NVMe LBA) supported by the CXL. io protocol by a NVMe device driver of a Linux kernel to realize a data read/write process. According to some example embodiments, the application may be an application processor or an application-specific integrated circuit (ASIC). In some example embodiments, the application may be processing circuitry, a processor configured to execute a program of instructions, etc., but example embodiments are not limited thereto.

Moreover, in some example embodiments, the MS SSD may support a prefetch command, so that data (e.g., embedding vectors) required, or alternatively desired or advantageous, for a preset number of batches of input data currently to be processed (e.g., the first input data) may be prefetched in advance from the NAND to the DRAM for high-bandwidth reading via the CXL. mem. Alternatively, in some example embodiments, the prefetch interface of the MS SSD may be used to prefetch the required, desired, or advantageous embedding vectors stored in the NAND to the DRAM in advance.

For example, the NAND with 4T of the MS SSD may store an embedding table that would occupy a lot of video memory of the GPU. In some example embodiments, a NAND with 4T may be, for example, a 4-terabyte NAND flash memory, but example embodiments are not limited thereto. Embedding vectors required, desired, or advantageous for a future batch are known during the training process of the preset model, and the MS SSD may prefetch the vectors required, desired, or advantageous for the future batch into the DRAM in advance and may read the prefetched vectors via the CXL. mem, realizing the characteristics of high bandwidth and low latency.

According to some example embodiments of the present disclosures, the embedding table lookup during the training of the preset model may be offloaded to the MS SSD, while all the learning modules (e.g., those for deep learning, etc.) may still be retained on the GPU for efficiency purposes. The MS SSD only be configured to transfer the embedding vectors to the GPU and receive the updated embedding vectors from the GPU.

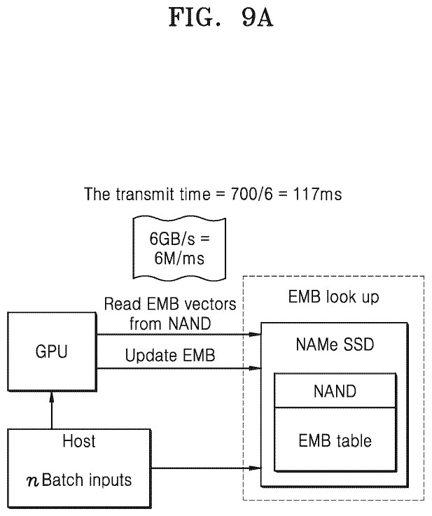

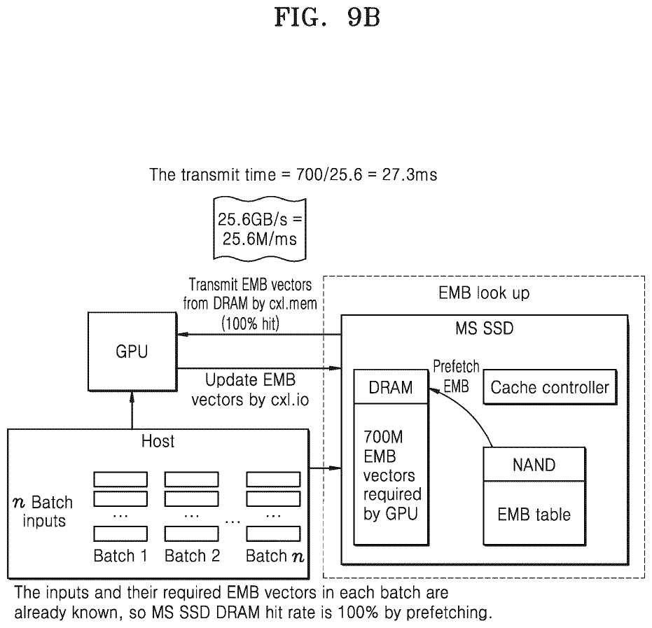

FIGS. 9A-9B illustrates a schematic diagram of comparison between example operations of a NVMe SSD and an MS SSD according to some example embodiments of the present disclosures, respectively, in a training process of a deep learning recommendation model.

Referring to FIGS. 9A-9B, according to some example embodiments of the present disclosures, all input data in a host is, or may be, divided into n batches in advance during the training process of the deep learning recommendation model.

Referring to FIG. 9A, an example of NVMe SSD (Non-Volatile Memory Express Solid State Disk/Drive) in combination with a GPU is illustrated. In an operation of the NVMe SSD and GPU in the training process of the deep learning recommendation model, an embedding table may be stored in a NAND in the NVMe SSD. During the training process of the deep learning recommendation model, the host may transfer or send information (e.g., indexes, etc.) of embedding vectors required or desired for input data to the NVMe SSD and perform embedding table lookup in the NAND of the NVMe SSD. The GPU may read the looked-up embedding vectors required or desired for the input data in the NAND. The GPU may receive the input data from a host to perform the training process of the deep learning recommendation model based on the input data and the corresponding embedding vectors and may update the embedding vectors, and may finally update the embedding table stored in the NAND of the NVMe SSD according to the updated embedding vectors.

Referring to FIG. 9B, a MS SSD according to some example embodiments of the present disclosures in combination with a GPU is illustrated. In an operation of the MS SSD according to some example embodiments of the present disclosures in combination with the GPU in the training process of the deep learning recommendation model, an embedding table may be stored in a NAND in the MS SSD. During the training process of the deep learning recommendation model, input data and its required, desired, or advantageous embedding vectors are known in each batch. The host may transfer or send, to the MS SSD, information (e.g., indexes, etc.) of embedding vectors required, desired, or advantageous for a preset plurality of batches of input data that are currently to be processed, and may perform embedding table lookup in the MS SSD. The looked-up embedding vectors may be prefetched from the NAND to a DRAM via a cache controller. The MS SSD may transfer or send the looked-up embedding vectors from the DRAM to the GPU via the CXL.mem. The GPU may perform the training process of the deep learning recommendation model based on the input data received from the host and the corresponding embedding vectors, update the embedding vectors, and finally may update the updated embedding vectors to the embedding table stored in the MS SSD via the CXL.io.

According to some example embodiments of the present disclosures, for example, for 700 M embedding vectors, a read speed of the NVMe SSD is 6 GB/s (6 M/ms), and a transmission time is 700/6=117 ms, whereas a read speed of the MS SSD with the CXL. mem is 25.6 GB/s (25.6 M/ms), and a transmission time may be reduced to 700/25.6=27.3 ms, which shows that the MS SSD may better match the training speed of the GPU.

Moreover, according to some example embodiments, since the input data and its required, desired, or advantageous embedding vectors are known in each batch, the embedding vectors required, desired, or advantageous for training may be fully prefetched in the DRAM of the MS SSD to achieve a 100% cache hit rate, thereby realizing the ability to read from the DRAM faster.

According to some example embodiments of the present disclosures, when processing a current batch of data of the input data, embedding vectors corresponding to second input data and not saved in the GPU may be prefetched from the DRAM into the GPU, wherein the second input data is a first batch of data to be processed of the input data. Embedding vectors corresponding to third input data and not saved in the GPU may be prefetched from the NAND into the DRAM, wherein the third input data is a second batch of data to be processed of the input data.

According to some example embodiments of the present disclosures, during the training process of the preset model, the prefetching process may be executed in a pipeline form to prefetch a next batch (e.g., (n+1)th batch) of input data (e.g., a first batch of data currently to be processed, that is the second input data) from the DRAM of the MS SSD into the GPU when performing training based on a current batch (e.g., nth batch) of input data, and prefetch a second batch (e.g., (n+2)th batch) of input data currently to be processed (e.g., the third input data) from the NAND into the DRAM, so as to ensure the smoothness and timeliness of the prefetching process and enhance the training efficiency of the preset model when processing (e.g., training of the preset model) according to respective batches of input data in sequence. Moreover, in some example embodiments, since embedding vectors required, desired, or advantageous between batches may be duplicated, and the transmission or sending of these data back and forth between the MS SSD and the GPU will increase the data transmission or sending burden and cause a data transmission or sending bottleneck, only embedding vectors that are not currently saved in the GPU may be prefetched during the prefetching process to minimize the data transmission or sending redundancy. For example, in determining whether the GPU currently saves a certain, or alternatively desired, embedding vector, the judgment or determination may be made based on an index corresponding to the embedding vector.

According to some example embodiments of the present disclosures, information about embedding vectors saved in the GPU may be recorded or stored by a pre-set prefetch management queue; information about the perfected embedding vectors corresponding to the second input data may be updated to the information recorded or stored by the prefetch management queue.

According to some example embodiments of the present disclosures, prefetch management may be performed by maintaining a queue Q (e.g., the prefetch management queue), which may be configured to contain or store information (e.g., indexes, etc.) of embedding vectors that have been previously transferred or sent to the GPU and are still currently stored in the GPU. The prefetch management may prefetch embedding vectors required, desired, or advantageous for input data from the NAND of the MS SSD to the DRAM of the MS SSD and from the DRAM of the MS SSD to the GPU while maintaining the queue Q.

For a next batch, the MS SSD may only need to transfer embedding vectors whose indexes are not in the queue Q to reduce the data transmission or sending burden. After training based on one batch, indexes corresponding to embedding vectors that will not be used in a subsequent batch are deleted from the queue Q, thus freeing up the memory of the GPU, and the updated embedding vectors are transferred or sent back to the MS SSD.

For example, when the nth batch is used for training, vectors required, desired, or advantageous for the next batch (e.g., the (n+1)th batch) and are not in the GPU will be prefetched from the DRAM of the MS SSD to the GPU, and the corresponding prefetch state of the prefetch management queue Q may be updated; and vectors required, desired, or advantageous for the (n+2)th batch and are not in the GPU will be prefetched from the NAND of the MS SSD to the DRAM of the MS SSD.

According to some example embodiments of the present disclosures, it can be understood that information about the embedding vectors stored in the GPU may also be managed by data structures such as arrays, linked lists, and the like, to realize prefetch management.

According to some example embodiments of the present disclosures, it is assumed that a total of 10 million unique embedding vectors are required, desired, or advantageous for a batch, and a size of an embedding vector is 64 B, the MS SSD may need to transfer about 700 M embedding vectors to the GPU for training based on the batch, and at the same time, the GPU may also need to transfer 700 M updated embedding vectors to the MS SSD. Thus, for example, there may be 50% duplicates of the required, desired, or advantageous embedding vectors between batches. With prefetch management, only 350 M of data may need to be transferred or sent to the MS SSD in a batch.

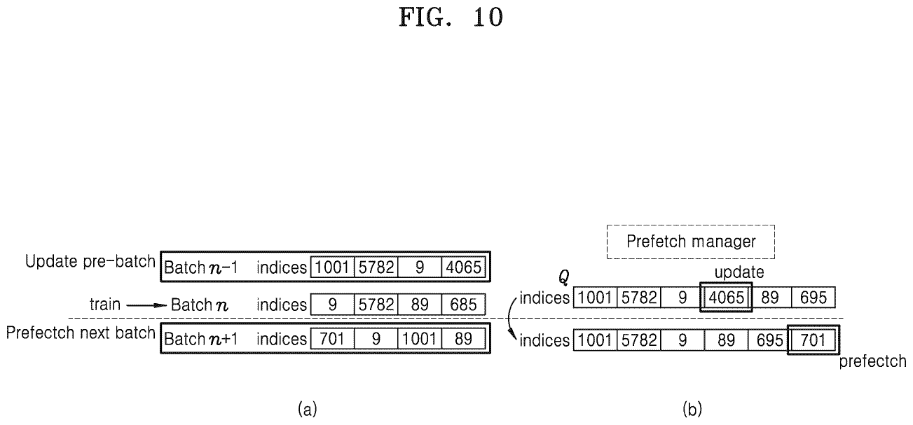

FIG. 10 illustrates a schematic diagram of comparison between an example of prefetching embedding vectors and a prefetch management scheme according to some example embodiments of the present disclosures.

Referring to (a) in FIG. 10, for example, embedding vectors with indexes (indices) [9, 5782, 89, 605] may be required or advantageous for a current batch n that is being used for training. When training based on the current batch n, the MS SSD may need to transfer or send prefetched embedding vectors for a next batch (e.g., batch n+1) to the GPU, e.g., indexes of embedding vectors for the batch n+1 may be [701, 9, 1001, 89], while the GPU may also need to transfer or send updated embedding vectors of a previous batch (e.g., batch n−1) to the MS SSD, e.g., index of embedding vectors of the batch n−1 may be [1001, 5782, 9, 4065]. It may be seen that the embedding vectors with the indexes [1001, 5782, 9, 89] are duplicated between the three batches, and it may require multiple transmissions between the MS SSD and the GPU.

Referring to (b) in FIG. 10, according to some example embodiments of the present disclosures, indexes of embedding vectors currently saved in the GPU may be recorded by prefetch management (e.g., the prefetch manager) using a queue Q. For example, indexes of embedding vectors used in training based on a previous batch and indexes of embedding vectors required, desired, or advantageous for training based on a current batch are recorded in the prefetch management queue Q. For example, the indexes are [1001, 5782, 9, 4065, 89, 695]. If indexes of embedding vectors that are still required, desired, or advantageous for the current batch and a next batch are [1001, 5782, 9, 89, 695], and an index of an embedding vector that is no longer required, desired, or advantageous is [4065], after training based on the previous batch is completed, only the embedding vector with the index may be updated to the MS SS from the GPU by comparing the information recorded in the prefetch management queue Q, while the embedding vectors with the indexes [1001, 5782, 9, 89, 695] are still saved in the GPU for subsequent training; meanwhile, a state of the embedding vectors currently saved in the GPU is updated to the information recorded by the prefetch management queue Q. For example, the data recorded in the prefetch management queue Q may be updated to the indexes [1001, 5782, 9, 89, 695] of the embedding vectors that are still required, desired, or advantageous for the current batch and the next batch. For embedding vectors required, desired, or advantageous for the next batch, it may be known by comparing the information recorded in the prefetch management queue Q that embedding vectors with indexes [9, 1001, 89] are already stored in the GPU, then only a remaining embedding vector with an index [701] may be prefetched from the MS SSD to the GPU when training based on the current batch.

The above is only a simple example according to some example embodiments, and in practice, there are a large or larger number of duplicates in embedding vectors required or advantageous for each batch of input data.

Referring back to FIG. 7, in some example embodiments, at operation 703, updated embedding vectors may be obtained by training the preset model based on the embedding vectors through the GPU.

According to some example embodiments of the present disclosures, the processes of training, validation, testing, and the like of the preset model may be performed in the GPU, to ensure the generation efficiency of the preset model through the computational power of the GPU.

According to some example embodiments of the present disclosures, the preset model may be trained based on embedding vectors corresponding to a current batch of data in the input data through the GPU to obtain updated embedding vectors; information about embedding vectors that are not required, desired, or advantageous for the first input data may be deleted from the GPU.

According to some example embodiments of the present disclosures, after training based on the current batch of input data is completed, updated embedding vector may be obtained, embedding vectors that are required, desired, or advantageous for a preset plurality of batches of input data currently to be processed (e.g., the first input data) may be still stored in the GPU, and embedding vectors that are not required, desired, or advantageous for the preset plurality of batches of input data currently to be processed may be deleted from the GPU, thereby freeing up storage space in the GPU.

According to some example embodiments of the present disclosures, embedding vectors corresponding to each batch of data of the first input data may be checked. A frequency of occurrence of each embedding vector among all the embedding vectors corresponding to each batch of data of the first input data may be counted. In some example embodiments, where training of the preset model has been completed based on the embedding vectors corresponding to the current batch of data of the input data, a frequency of occurrence of each embedding vector corresponding to the current batch of data may be subtracted from the counted frequency of occurrence of each embedding vector, correspondingly. An embedding vector whose frequency of occurrence is subtracted to 0 may be deleted from the GPU.

According to some example embodiments of the present disclosures, recording of batch information may be managed by a pre-set prefetch management queue, and therefore, information about the embedding vector whose frequency of occurrence is subtracted to 0 may be deleted from the information recorded by the prefetch management queue.

According to some example embodiments of the present disclosures, the first input data may be a batch n+1 to n+l of data currently to be processed of the input data, n is the current batch, and a size of l is a size of a remaining video memory of the GPU divided by a size of all embedding vectors corresponding to one batch of data.

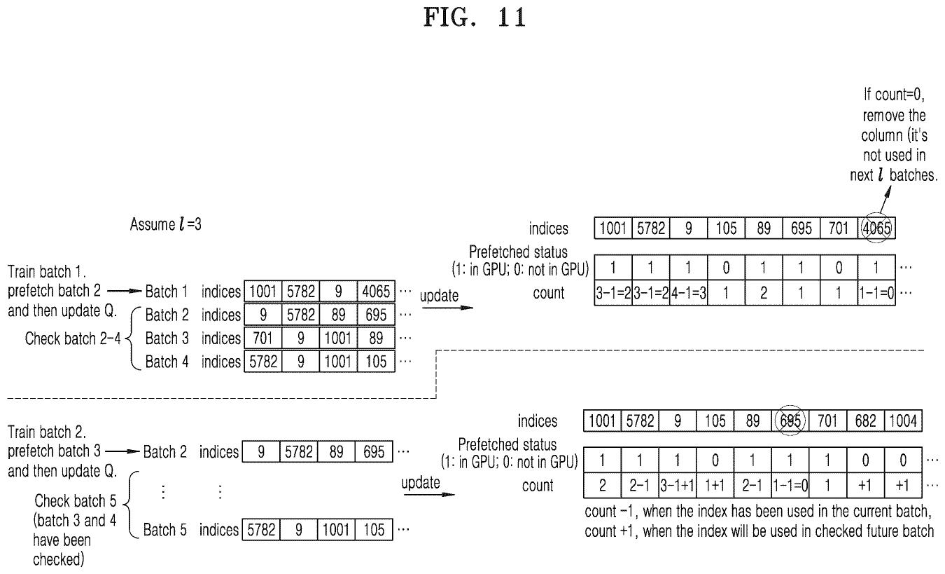

FIG. 11 illustrates a schematic diagram of an operation flow for updating a prefetch state according to some example embodiments of the present disclosures.

Referring to FIG. 11, according to some example embodiments of the present disclosures, in order to update embedding vectors updated after training to the MS SSD and to free up the video memory space in the GPU, embedding vectors required, desired, or advantageous for batches n+1 to n+l of input data (e.g., the first input data) may be checked if the training based on the nth batch is currently being performed.

For indexes of embedding vectors required, desired, or advantageous for each batch of input data in the checked batches, their corresponding counts are added by 1, which means that the embedding vectors corresponding to these indexes will be used again in the future; for indexes of embedding vectors that have already been used in the current batch, their corresponding counts are subtracted by 1; when a certain count is 0, it means that an embedding vector of a corresponding index will not be used in the next l batches, and a corresponding embedding vector may be updated to the MS SSD and deleted from the GPU.

For example, it is assumed that l=3, when training based on a first batch, embedding vectors corresponding to a second batch may be prefetched, and the prefetched embedding vectors may be updated to the prefetch state recorded in the prefetch management queue Q. Further, the counting information recorded in the prefetch management queue Q may be updated based on indexes of embedding vectors required, desired, or advantageous for checked total 3 batches from the second to fourth batches of input data.

The prefetch management queue Q may contain the following information: (1) indexes (indices) of embedding vectors required or advantageous for a current batch, a previous batch, and checked 3 batches after the current batch; (2) prefetch state information indicating whether an embedding vector corresponding to each index has been prefetched, e.g., whether the embedding vector corresponding to each index is stored in the GPU. In some example embodiments, where it is saved in the GPU, the prefetch state being recorded as“1” means that the embedding vector corresponding to the index does not need to be prefetched after training based on the current batch is completed, while the prefetch state being recorded as“0” means that the embedding vector corresponding to the index needs to be prefetched after the training based on the current batch is completed; (3) count information indicating a total number of times an embedding vector corresponding to each index needs to be reused in the current batch and three checked batches. For an embedding vector that has been used in the current batch, the count of its corresponding index is reduced by 1, and when the count is 0, it means that the embedding vector of the corresponding index will not be used in the next three batches (e.g., the second to fourth batches), and a column with a count of 0 in the prefetch management queue Q may be deleted, e.g. a column with the index [4065] is deleted.

When training is performed based on the second batch, embedding vectors corresponding to the third batch may be prefetched, and the prefetched embedding vectors may be updated to the prefetch state recorded in the prefetch management queue Q. Further, the count information recorded in the prefetch management queue Q may be updated based on indexes of embedding vectors required, desired, or advantageous for checked total 3 batches from the third to fifth batches of input data. Since indexes of embedding vectors required, desired, or advantageous for the third to fourth batches of input data have been checked when training based on the first batch, it is, or may be, possible to check only indexes of embedding vectors required, desired, or advantages for the fifth batch of input data when training based on the second batch. For embedding vectors required, desired, or advantageous for a future batch (e.g., the fifth batch at this time), counts of corresponding indexes recorded in the prefetch management queue Q may be added by 1, respectively. Counts corresponding to indexes (e.g., the index [695]) of embedding vectors that are not required or advantageous for next three batches (e.g., the third to fifth batches) of input data may be reduced to 0, and columns in which they are located will be deleted.

Referring back to FIG. 7, in some example embodiments, at operation 704, the updated embedding vectors may be transferred or sent from the GPU to the MS SSD for updating the embedding table.

According to some example embodiments of the present disclosures, a collection of frequent access sets may be centrally written into a preset region of a NAND of the MS SSD, wherein the collection of frequent access sets is a collection of embedding vector sets that are accessed more frequently than a first preset value.

According to some example embodiments of the present disclosures, since a basic operating unit (e.g., lookup, read/write, etc.) of a NAND-type Flash (e.g., flash memory) is a page, and a plurality of embedding vectors are usually stored in a page. If embedding vectors required, desired, or advantageous for input data are sparsely stored in various portions of the NAND of the MS SSD, the embedding table lookup, read and write result in simultaneous operation of a large amount of redundant data, reduce the operation efficiency and cause high latency, e.g., the read amplification problem.

For example, a size of an embedding vector is usually 64B to 1KB, while a size of a flash page is usually larger than 4KB. Since the low spatial locality of the embedding table, during the prefetching process, both required, desired, or advantageous vectors and vectors that are not required, desired, or advantageous are prefetched together on a same page, which reduces the amount of effective prefetching and the cache efficiency of the DRAM.

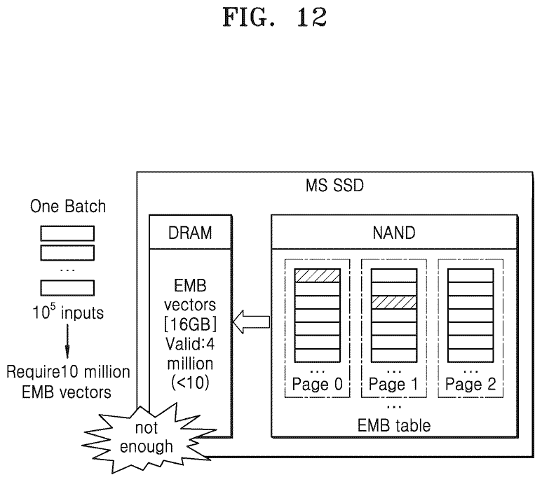

FIG. 12 illustrates an example schematic diagram of read amplification due to low spatial locality of an embedding table.

Referring to FIG. 12, it is assumed that a DRAM has a capacity of 16 GB and an embedding vector is 64 B. If there are 100,000 inputs in one batch and each input requires 150 embedding vectors, after removing duplicates among the embedding vectors required, desired, or advantageous for the inputs, a total of about 10 million embedding vectors are still required, desired, or advantageous. If these embedding vectors are distributed on different pages (Page 0~2, etc. in FIG. 12), due to the limitation of the DRAM capacity, only 4 million valid vectors may be prefetched, and the requirement of prefetching 10 million embedding vectors cannot be reached.

Therefore, a collection of frequent vector sets that are required, desired, or advantageous multiple times (e.g., access frequency is greater than a first preset value) in multiple different inputs during the embedding table lookup may be centrally written into one or more pages of the NAND of the MS SSD to achieve embedding offloading and to improve the operation efficiency of the NAND during the training of the preset model. It will be appreciated that the access frequency being greater than the first preset value may include situations such as a required or desired number of accesses to a same embedding vector is greater than 2 for a plurality of neighboring batches of input data.

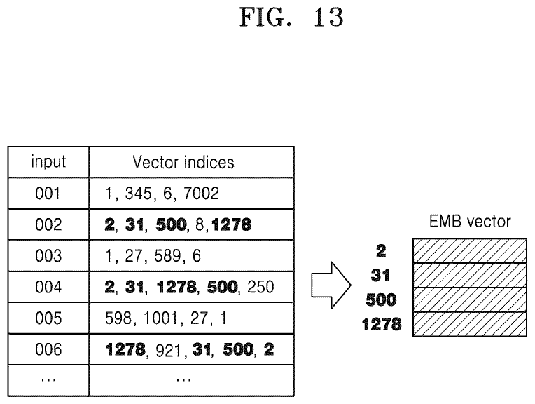

FIG. 13 illustrates a schematic diagram of an operation of embedding offloading according to some example embodiments of the present disclosures.

Referring to FIG. 13, according to some example embodiments of the present disclosures, for example, a set of embedding vectors with indexes [2, 31, 500, 1278], which is regarded as a frequent vector set in FIG. 4, may be centrally written into one or more pages of the NAND of the MS SSD to achieve embedding offloading and increase spatial locality.

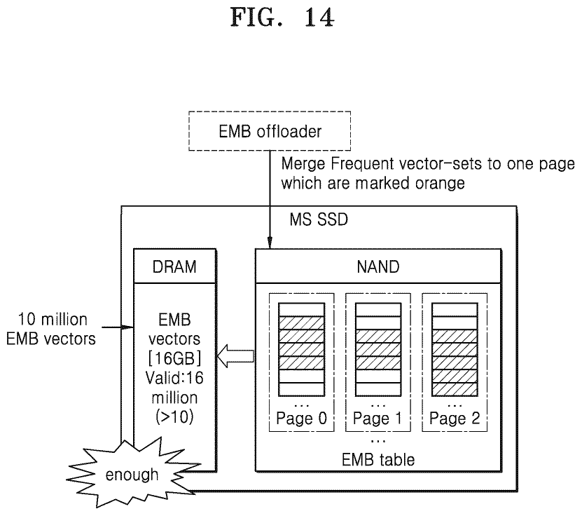

FIG. 14 illustrates a schematic diagram of optimizing read amplification by embedding offloading according to some example embodiments of the present disclosures.

Referring to FIG. 14, according to some example embodiments of the present disclosures, frequent vector sets may be merged by embedding offloading, and the merged frequent vector sets are marked in orange (e.g., shaded) in FIG. 14. It may still be assumed that the DRAM has a capacity of 16 GB and an embedding vector is 64 B. If a batch requires, or is beneficial to have, a total of about 10 million embedding vectors, by embedding offloading, it is possible to make it more likely that a plurality of vectors on a same page in the NAND are accessed by a single input at the same time, thereby reducing read amplification and improving cache efficiency. Since a frequent vector set usually has 4-10 vectors, these frequent vector sets are merged and stored so that the number of vectors that may actually be accessed in the DRAM cache may be increased by at least four times. For example, it may be possible to prefetch a total of 16 million valid vectors. Even if the DRAM has a limited or reduced capacity, it is more likely to prefetch 10 million embedding vectors.

According to some example embodiments of the present disclosures, a mapping relationship between indexes of all embedding vectors corresponding to the collection of frequent access sets and indexes of which after merging and writing may be recorded in a mapping table to facilitate maintenance of the mapping relationship between original indexes and new indexes after merging in the mapping table.

According to some example embodiments of the present disclosures, a frequency of occurrence of each embedding vector set among all embedding vectors corresponding to each data of fourth input data may be counted, and a collection of longest embedding vector sets whose frequency of occurrence are greater than a second preset value may be used as the collection of frequent access sets, wherein the fourth input data is a preset plurality of data in the input data. All embedding vectors corresponding to the collection of frequent access sets may be merged and written into the preset region of the NAND, wherein the preset region of the NAND includes a page in the NAND.

According to some example embodiments of the present disclosures, a collection of embedding vector set with the highest number of vectors required or advantageous for two or more inputs at the same time, e.g., the collection of longest embedding vector sets whose frequency of occurrence are greater than the second preset value, may be counted in x inputs (e.g., the preset plurality of data in the input data, e.g., the fourth input data) to obtain the collection of frequent access sets. Where x is an integer larger than one.

According to some example embodiments of the present disclosures, a size of this x may be a number of inputs corresponding to a collection of frequent vector sets that is written to a same page of the NAND when a number of embedding vectors that can be stored on the same page of the NAND is used as a length of the collection of frequent vector sets. For all input data, a collection of frequent vector sets corresponding to every x inputs therein may be obtained sequentially and written sequentially to a same page of the NAND.

According to some example embodiments of the present disclosures, k may be preset to be an integer greater than or equal to 1, and the following steps may be performed in a loop: counting a frequency of occurrence of each pending embedding vector set among all embedding vectors corresponding to each data of the fourth input data, and using a collection of pending embedding vector sets whose frequency of occurrence are greater than the second preset value(e.g., 1) as a collection Lₖ of pending frequent access sets, wherein the pending embedding vector set contains information corresponding to k embedding vectors (e.g., indexes of the embedding vectors); combining pending embedding vector sets having k−1 common embedding vectors among the pending embedding vector sets of Lₖ by pairs, to obtain at least one updated pending embedding vector set; using the collection Lₖ of the pending frequent access sets as the collection of frequent access sets and ending the current loop in a case where a preset condition is satisfied, wherein the preset condition is that k is equal to a maximum number of embedding vectors that can be stored on one page of the NAND, or that it cannot find at least one updated pending embedding vector set from each embedding vector set corresponding to the fourth input data; in a case where the preset condition is not satisfied, assigning k to k+1.

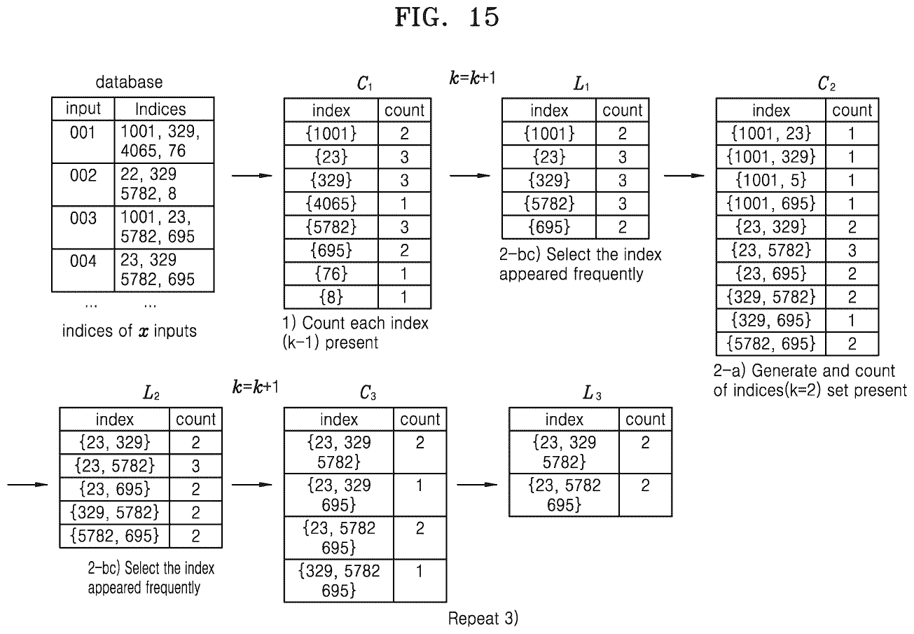

FIG. 15 illustrates a schematic diagram of an algorithmic flow for counting a frequent access set by index according to some example embodiments of the present disclosures.

Referring to FIG. 15, according to some example embodiments of the present disclosures, a set of frequently accessed embedding vectors (e.g., a collection of frequent access sets) may be counted by index. An embedding offloader may count a set of indexes corresponding to the set of frequently accessed embedding vectors through index information (e.g., data table) of embedding vectors required, desired, or advantageous in each of x inputs respectively. Specifically, in some example embodiments, the following steps (1) to (3) may be included:
(1)A constant k may be assumed and let k=1, and a table may be created containing a count of indexes corresponding to each embedding vector required or advantageous for x inputs, denoted as a candidate set C₁ (e.g., a collection of pending embedding vector sets C₁);
(2)Finding an index set of indexes of embedding vectors that are accessed frequently and have a length of k, denoted as k-index set:
(2-a) Counting a frequency of occurrence of the k-index set in the data table, denoted as a candidate set Cₖ (e.g., a collection of pending embedding vector sets Cₖ);
(2-b) Comparing the frequency of occurrence of each index set (e.g., the pending embedding vector set) in the candidate set Cₖ with a given minimum count, which may be 1 in FIG. 15, and if there is an index set in the candidate set Cₖ, the number of times the index set appears in the data table being less than or equal to the minimum count, deleting the index set and get remaining k sets (e.g., Lₖ) which appear more frequently (in some example embodiments, it means that the collection of pending embedding vector sets with frequency of occurrence greater than 1 is used as the collection Lₖ of pending frequent access sets);
(2-c) Performing a connect step, which may use Lₖ to generate a next candidate set Cₖ₊₁, e.g., two sets with k−1 common elements in Lₖ may be connected to generate the candidate set Cₖ₊₁.
(3) Repeating step (2) until k equals to the maximum number of embedding vectors that can be stored on a page of the NAND or a set in Lₖ can no longer be found from the data table.

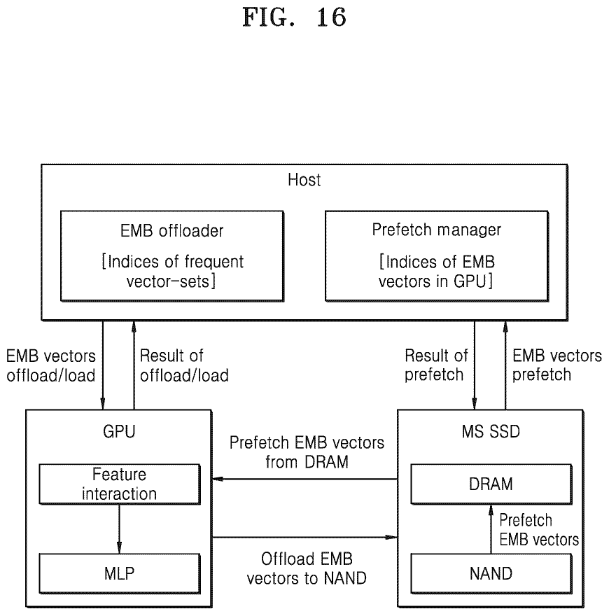

FIG. 16 illustrates a schematic diagram of an operation combining embedding offloading and prefetch management according to some example embodiments of the present disclosures.

Referring to FIG. 16, according to some example embodiments of the present disclosures, two components, embedded offloader and prefetch management, may be combined in order to reduce read amplification and to resolve data transmission or sending bottlenecks. A control module for the embedded offloader and the prefetch management may be implemented in a host, and the host may receive control results of the embedded offloader and the prefetch management.

For the embedding offloader, indexes of a set of frequently accessed embedding vectors that are needed or desired in different inputs at the same time may be counted by the host, and the set of these frequently accessed vectors may be merged and written to a same page of the NAND of the MS SSD to increase spatial locality and reduce read amplification.

For the prefetch management, since there will be duplicates of embedding vectors required or advantageous for successive training batches, a queue may be maintained in the host to manage vectors that have already been prefetched in the GPU. To minimize the data transmission or sending burden, only new required or advantageous vectors that are not in the GPU are prefetched, and vectors that are not required or advantageous in subsequent batches are deleted from the queue and their updated values may be written to the NAND.

In the MS SSD, according to some example embodiments, one-level prefetching also exists, where embedding vectors saved in the NAND are prefetched into the DRAM to improve data read speed.

Performing the feature interaction and MLP process in the GPU may efficiently use the computational resources of the GPU to enhance the training efficiency of the preset model.

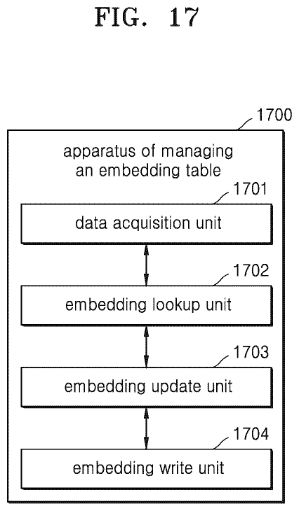

FIG. 17 illustrates a block diagram of an apparatus of managing an embedding table according to some example embodiments of the present disclosures.

Referring to FIG. 17, some example embodiments of the present disclosures provide an apparatus 1700 of managing an embedding table, which may include, but is not limited to, a data acquisition unit 1701, an embedding lookup unit 1702, an embedding update unit 1703, and an embedding write unit 1704.

The data acquisition unit 1701 may acquire input data.

The embedding lookup unit 1702 may look up embedding vectors corresponding to the input data from an embedding table of a preset model in a memory semantic SSD (MS SSD), and transfer the embedding vectors from the MS SSD to a GPU. Alternatively, in some example embodiments, the embedding table of the preset model may be pre-stored or stored in the memory semantic SSD (MS SSD)

The embedding update unit 1703 may train the preset model based on the embedding vectors by the GPU to obtain updated embedding vectors.

The embedding write unit 1704 may transfer the updated embedding vectors from the GPU to the MS SSD for updating the embedding table.

According to some example embodiments of the present disclosures, the MS SSD includes a NAND and a DRAM and the embedding table of the preset model is stored in the NAND. The embedding lookup unit 1702 may prefetch embedding vectors corresponding to first input data from the NAND into the DRAM through a prefetch interface of the MS SSD, wherein the first input data is a preset plurality of batches of data currently to be processed of the input data; transfer the embedding vectors corresponding to the first input data from the DRAM to the GPU.

According to some example embodiments of the present disclosures, the embedding lookup unit 1702 may further prefetch, from the DRAM into the GPU, embedding vectors corresponding to second input data and not saved in the GPU, when processing a current batch of data of the input data, wherein the second input data is a first batch of data to be processed of the input data; prefetch, from the NAND into the DRAM, embedding vectors corresponding to third input data and not saved in the GPU, wherein the third input data is a second batch of data to be processed of the input data.

According to some example embodiments of the present disclosures, the apparatus 1700 may further include an embedding prefetch unit (not shown) which may record information about embedding vectors saved in the GPU by a pre-set prefetch management queue and update information about the perfected embedding vectors corresponding to the second input data to the information recorded by the prefetch management queue.

According to some example embodiments of the present disclosures, the embedding update unit 1703 may train the preset model based on embedding vectors corresponding to the current batch of data of the input data by the GPU to obtain the updated embedding vectors; delete information about embedding vectors that are not required or advantageous for the first input data from the GPU.

According to some example embodiments of the present disclosures, the embedding update unit 1703 may check embedding vectors corresponding to each batch of data of the first input data and count a frequency of occurrence of each embedding vector among all the embedding vectors corresponding to each batch of data of the first input data; in a case where training of the preset model has been completed based on the embedding vectors corresponding to the current batch of data of the input data, subtract a frequency of occurrence of each embedding vector corresponding to the current batch of data from the counted frequency of occurrence of each embedding vector, correspondingly; and delete an embedding vector whose frequency of occurrence is subtracted to 0 from the GPU.

According to some example embodiments of the present disclosures, the embedding update unit 1703 may delete information about the embedding vector whose frequency of occurrence is subtracted to 0 from the information recorded by the prefetch management queue.

According to some example embodiments of the present disclosures, the first input data may be a batch n+1 to n+l of data currently to be processed of the input data, n is the current batch, and a size of l is a size of a remaining video memory of the GPU divided by a size of all embedding vectors corresponding to one batch of data.

According to some example embodiments of the present disclosures, the apparatus 1700 may further include an embedding merge unit (not shown) which may write a collection of frequent access sets centrally into a preset region of a NAND of the MS SSD, wherein the collection of frequent access sets is a collection of embedding vector sets that are accessed more frequently than a first preset value.

According to some example embodiments of the present disclosures, the embedding merge unit may count a frequency of occurrence of each embedding vector set among all embedding vectors corresponding to each data of fourth input data, and use a collection of longest embedding vector sets whose frequency of occurrence are greater than a second preset value as the collection of frequent access sets, wherein the fourth input data is a preset plurality of data in the input data; merge and write all embedding vectors corresponding to the collection of frequent access sets into the preset region of the NAND, wherein the preset region of the NAND includes a page in the NAND.

According to some example embodiments of the present disclosures, the apparatus 1700 may further include an index mapping unit (not shown) which may record, in a mapping table, a mapping relationship between indexes of all embedding vectors corresponding to the collection of frequent access sets and indexes of which after merging and writing.

According to some example embodiments of the present disclosures, the embedding merge unit may preset k to be an integer greater than or equal to 1, and loop through the following steps of: counting a frequency of occurrence of each pending embedding vector set among all embedding vectors corresponding to each data of the fourth input data, and using a collection of pending embedding vector sets whose frequency of occurrence are greater than the second preset value as a collection Lₖ of pending frequent access sets, wherein the pending embedding vector set contains information corresponding to k embedding vectors; combining pending embedding vector sets having k−1 common embedding vectors among the pending embedding vector sets of Lₖ by pairs, to obtain at least one updated pending embedding vector set; using the collection Lₖ of the pending frequent access sets as the collection of frequent access sets and ending the current loop in a case where a preset condition is satisfied, wherein the preset condition is that k is equal to a maximum number of embedding vectors that can be stored on one page of the NAND, or that it cannot find at least one updated pending embedding vector set from each embedding vector set corresponding to the fourth input data; in a case where the preset condition is not satisfied, assigning k to k+1.

It may be understood that the example implementation process in the above example embodiments of the apparatus 1700 of managing an embedding table is substantially the same as that in the above example embodiments of the method of managing an embedding table, and will not be described repeatedly herein. The apparatus 1700 for managing an embedding table may be configured as software, hardware, firmware, or any combination of the foregoing items for performing specific functions, respectively. For example, these apparatus may correspond to dedicated integrated circuits, or to pure software codes, or to modules that combines software and hardware. In some example embodiments, one or more of the functions implemented by these apparatuses may also be uniformly performed by components in a physical entity device (e.g., a processor, client, or server, etc.).

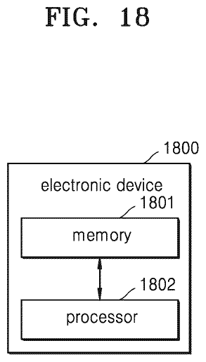

FIG. 18 is a block diagram of an electronic device according to some example embodiments of the present disclosures.

Referring to FIG. 18, an electronic device 1800 includes at least one memory 1801 and at least one processor 1802, the at least one memory 1801 stores a computer-executable instruction set, when the computer-executable instruction set is executed by the at least one processor 1802, a method of managing an embedding table according to some example embodiments of the present disclosures is performed.

According to some example embodiments, the electronic device 1800 may be a PC computer, a tablet apparatus, a personal digital assistant, a smart phone, or any other apparatus capable of executing the above instruction set, but example embodiments are not limited thereto. According to some example embodiments, the electronic device 1800 does not have to be a single electronic device, but may also be any set of apparatuses or circuits capable of executing the above instructions (or instruction set) individually or jointly. The electronic device 1800 may also be a part of an integrated control system or system manager, or may be configured as a portable electronic device that interfaces locally or remotely (e.g., via wireless transmission).

In electronic device 1800, the processor 1802 may include central processing units (CPUs), graphics processing units (GPUs), programmable logic apparatuses, special purpose processor systems, microcontrollers or microprocessors. By way of example and not limitation, according to some example embodiments, the processor may also include analog processors, digital processors, microprocessors, multi-core processors, processor arrays, network processors, and the like.

The processor 1802 may execute instructions or code stored in the memory 1801, which may also store data. Instructions and data may also be transmitted or sent and received over a network via a network interface apparatus, which may employ any known transport protocol.

The memory 1801 may be integrated with the processor 1802, e.g., a RAM or flash memory is arranged within an integrated circuit microprocessor or the like. In some example embodiments, the memory 1801 may include a separate apparatus such as an external disk drive, storage array, or any other storage device that may be used by a database system. The memory 1801 and the processor 1802 may be operatively coupled, or may communicate with each other, e.g., through I/O ports, network connections, etc., to enable the processor 1802 to read files stored in the memory.

In some example embodiments, the electronic device 1800 may also include a video display (such as a liquid crystal display) and a user interaction interface (such as a keyboard, mouse, touch input device, etc.). All components of electronic device 1800 may be connected to each other via a bus and/or network.

According to some example embodiments of the present disclosures, there may also be provided a computer readable storage medium storing instructions, wherein the instructions, when run by at least one computing apparatus, cause the at least one computing apparatus to perform a method of managing an embedding table as described above according to some example embodiments.

Examples of computer readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer may execute the computer programs. The instructions or computer programs in the computer readable storage medium described above may be executed in an environment deployed in a computer device, such as client, host, proxy device, server, etc. In some example embodiments, the computer programs and any associated data, data files, and data structures are distributed on a networked computer system, so that the computer programs and any associated data, data files, and data structures are stored, accessed and executed through one or more processors or computers in a distributed manner. It should be noted that the instructions may also be used to perform additional steps in addition to the steps described above or to perform more specific processing when performing the steps described above, and the content of these additional steps and further processing has already been referred to in the process of describing the relevant methods, and will therefore not be repeated herein in order to avoid repetition.

Another example embodiment of the present disclosures may involve a system including at least one computing apparatus and at least one storage apparatus storing instructions, wherein the instructions, when run by the at least one computing apparatus, cause the at least one computing apparatus to perform a method of managing an embedding table according to some example embodiments of the present disclosures.

It should be noted that a system according to some example embodiments of the present disclosures may rely entirely on operation of a computer program or instructions to implement the corresponding functions, e.g., the individual units correspond to the steps in the functional architecture of the computer program, such that the entire system is invoked to implement the corresponding functions by means of specialized software packages (e.g., libraries).

On the other hand, in some example embodiments, when the above system is implemented as software, firmware, middleware, or microcode, program code or code segments for performing the corresponding operations may be stored in a computer readable medium, such as a storage medium, such that at least one processor or at least one computing apparatus may perform corresponding operations by reading and running the corresponding program code or code segments.

According to some example embodiments of the present disclosures, a storage apparatus may be integrated with a computing apparatus, e.g., RAM or a flash memory is deployed in an integrated circuit microprocessor, etc. In some example embodiments, the storage apparatus may include a separate apparatus, such as an external disk drive, a storage array, or any other storage apparatus that may be used by a database system. The storage apparatus and the computing apparatus may be operationally coupled or may communicate with each other, for example, via I/O ports, network connection, and the like, such that the computing apparatus is capable of reading instructions stored in the storage apparatus.

Another example embodiment of the present disclosures may involve a computer program product including a computer program/instruction, wherein the computer program/instruction, when run by a processor, may implement any method of managing an embedding table according to some example embodiments of the present disclosures.

The method, apparatus, electronic device, storage medium, system, and computer program product for managing an embedding table according to some example embodiments of the present disclosures may use the MS SSD for storing an embedding table, realizing a reduction in cost expenditure while being able to provide a larger storage capacity, and during a training process of a model, embedding table lookup is performed in the MS SSD, and updated embedding vectors are stored in the MS SSD to update the embedding table stored in the MS SSD, thus low-latency, high-bandwidth, and high-input-output performance may be achieved through dual interfaces of the MS SSD.

In some example embodiments, prefetching management is realized through the prefetch interface of the MS SSD, which may prefetch the required or advantageous data from the MS SSD to the DRAM of the MS SSD in advance, realizing a high or higher cache hit rate and high or higher bandwidth reading at the same time.

In some example embodiments, since the embedding vectors required, desired, or advantageous for successive training batches may be duplicated, in the process of prefetching the embedding vectors from the DRAM to the GPU each time, embedding vectors that are to be prefetched are filtered, and only embedding vectors that are not saved in the CPU are prefetched, which may reduce the amount of data transmission or sending between the MS SSD and the GPU, and thus reduce the bottleneck and burden of data transmission or sending, and free up the memory of the GPU.

In some example embodiments, a queue may be used to manage information (e.g., indexes, etc.) of embedding vectors required, desired, or advantageous for successive batches of input data to easily and efficiently reduce the number of embedding vectors to be transferred between the MS SSD and the GPU, thus solving the bottleneck of data transmission or sending.

In some example embodiments, when using the current batch of input data for model training, the embedding vectors that are not required, desired, or advantageous for the subsequent batch of input data may be deleted from the GPU, which may free up the memory space of the GPU.

In some example embodiments, since a page is a basic storage unit of the NAND (NOT AND Flash, which is a non-volatile memory chip in which a number of NAND gates form a logical architecture), a collection of frequently accessed embedding vector set are written centrally to a same page of the NAND, which enables embedding offloading to increase spatial locality and reduce read amplification, and the prefetching and storing of more required, desired, or advantageous embedding vectors may be realized with the same DRAM capacity, which improves the caching efficiency and increases the throughput of model training.

In some example embodiments, by optimizing the offloading and prefetching of the embedding table between the GPU and the MS SSD, a larger effective transmission or sending throughput between the GPU and the MS SSD may be achieved.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

The above describes various example embodiments of the present disclosures, and it should be understood that the above description is only of some example embodiments and is not exhaustive, and the present disclosures are not limited to the disclosed example embodiments. Without departing from the scope and spirit of the present disclosures, many modifications and changes will be apparent to a person of ordinary skill in the art. Therefore, the scope of protection of the present disclosures should be based on the scope of the claims.

1. A method of managing an embedding table by a processor, the method comprising
acquiring input data;
looking up embedding vectors corresponding to the input data from an embedding table of a model stored in a memory semantic solid state drive (MS SSD);
transferring the embedding vectors acquired from the MS SSD to a graphics processing unit (GPU); and
instructing the GPU to transfer updated embedding vectors to the MS SSD for updating the embedding table, the updated embedding vectors acquired by training the model based on the embedding vectors transferred to the GPU.

2. The method of claim 1, wherein the MS SSD comprises a non-volatile memory and a dynamic random-access memory (DRAM) and the non-volatile memory is configured to store the embedding table of the model;
the looking up of the embedding vectors comprises prefetching first embedding vectors corresponding to first input data from the non-volatile memory into the DRAM through a prefetch interface of the MS SSD, wherein the first input data is a plurality of batches of data currently to be processed of the input data; and
the transferring of the embedding vectors from the MS SSD to the GPU comprises transferring the first embedding vectors corresponding to the first input data from the DRAM to the GPU.

3. The method of claim 2, wherein the transferring of the embedding vectors from the MS SSD to the GPU further comprises prefetching second embedding vectors corresponding to second input data and not saved in the GPU from the DRAM into the GPU, in response to processing a current batch of data of the input data, wherein the second input data is a first batch of data to be processed of the input data; and
the looking up of the embedding vectors further comprises prefetching third embedding vectors corresponding to third input data and not saved in the GPU from the non-volatile memory into the DRAM, wherein the third input data is a second batch of data to be processed of the input data.

4. The method of claim 3, wherein the method further comprises:
recording information about the embedding vectors saved in the GPU by a prefetch management queue; and
updating information about the prefetched second embedding vectors corresponding to the second input data to the information recorded by the prefetch management queue.

5. The method of claim 3, wherein the training the model based on the embedding vectors by the GPU to obtain the updated embedding vectors comprises:
training the model based on the second embedding vectors corresponding to the current batch of data of the input data by the GPU to obtain the updated embedding vectors; and
deleting information about embedding vectors that are not required for the first input data from the GPU.

6. The method of claim 5, wherein the deleting the information about the embedding vectors that are not required for the first input data from the GPU comprises:
checking embedding vectors corresponding to each batch of data of the first input data and counting a frequency of occurrence of each embedding vector among all the embedding vectors corresponding to each batch of data of the first input data;
in response to the training of the model having been completed based on the second embedding vectors corresponding to the current batch of data of the input data, subtracting a frequency of occurrence of each embedding vector corresponding to the current batch of data from the counted frequency of occurrence of each embedding vector, correspondingly; and
deleting, from the GPU, an embedding vector whose frequency of occurrence is subtracted to 0.

7. The method of claim 6, wherein the deleting, from the GPU, the embedding vector whose frequency of occurrence is subtracted to 0 comprises:
deleting information about the embedding vector whose frequency of occurrence is subtracted to 0 from information recorded by a prefetch management queue.

8. The method of claim 2, wherein the first input data is a batch n+1 to n+l of data currently to be processed of the input data, n being a current batch, and a size of l being a size of a remaining video memory of the GPU divided by a size of all embedding vectors corresponding to one batch of data.

9. The method of claim 1, wherein the method further comprises:
writing a collection of frequent access sets centrally into a region of a non-volatile memory of the MS SSD, wherein the collection of frequent access sets is a collection of embedding vector sets that are accessed more frequently than a first value.

10. The method of claim 9, wherein the writing the collection of frequent access sets centrally into the region of the non-volatile memory of the MS SSD comprises:
counting a frequency of occurrence of each embedding vector set among all embedding vectors corresponding to each data of first input data, and using a collection of longest embedding vector sets whose frequency of occurrence are greater than a second value as the collection of frequent access sets, wherein the first input data is a plurality of data in the input data; and
merging and writing all embedding vectors corresponding to the collection of frequent access sets into the region of the non-volatile memory, wherein the region of the non-volatile memory comprises a page in the non-volatile memory.

11. The method of claim 10, wherein the method further comprises:
recording, in a mapping table, a mapping relationship between indexes of all the embedding vectors corresponding to the collection of frequent access sets and the indexes after the merging and writing.

12. The method of claim 10, wherein the counting the frequency of occurrence of each embedding vector set among all embedding vectors corresponding to each data of the first input data, and the using the collection of longest embedding vector sets whose frequency of occurrence are greater than the second value as the collection of frequent access sets comprises:
setting k to be an integer greater than or equal to 1;
counting a frequency of occurrence of each pending embedding vector set among all embedding vectors corresponding to each data of the first input data, and using a collection of pending embedding vector sets whose frequency of occurrence are greater than the second value as a collection Lₖ of pending frequent access sets, wherein the pending embedding vector set contains information corresponding to k embedding vectors;
combining pending embedding vector sets having k−1 common embedding vectors among the pending embedding vector sets of Lₖ by pairs, to obtain at least one updated pending embedding vector set;
determining whether a condition is satisfied, the condition being that k is equal to a maximum number of embedding vectors that can be stored on one page of the non-volatile memory, or that at least one updated pending embedding vector set from each embedding vector set corresponding to the first input data cannot be found;
using the collection Lₖ of the pending frequent access sets as the collection of frequent access sets in response to the condition being satisfied; and
assigning k to k+1 in response to the condition not being satisfied and repeating the counting, the combining, and the determining.

13. An apparatus configured to manage an embedding table, the apparatus comprising
a data acquisition unit configured to acquire input data;
an embedding lookup unit configured to
look up embedding vectors corresponding to the input data from an embedding table of a model stored in a memory semantic solid state drive (MS SSD), and
transfer the embedding vectors from the MS SSD to a graphics processing unit (GPU);
an embedding update unit configured to train the model based on the embedding vectors by the GPU to obtain updated embedding vectors; and
an embedding write unit configured to transfer the updated embedding vectors from the GPU to the MS SSD for updating the embedding table.

14. The apparatus of claim 13, wherein the MS SSD comprises a non-volatile memory and a dynamic random-access memory (DRAM) and the non-volatile memory is configured to store the embedding table of the model; and
the embedding lookup unit is configured to,
prefetch first embedding vectors corresponding to first input data from the non-volatile memory into the DRAM through a prefetch interface of the MS SSD, wherein the first input data is a plurality of batches of data currently to be processed of the input data; and
transfer the first embedding vectors corresponding to the first input data from the DRAM to the GPU.

15. The apparatus of claim 14, wherein the embedding lookup unit is further configured to:
prefetch, from the DRAM into the GPU, second embedding vectors corresponding to second input data and not saved in the GPU, in response to processing a current batch of data of the input data, wherein the second input data is a first batch of data to be processed of the input data; and
prefetch, from the non-volatile memory into the DRAM, third embedding vectors corresponding to third input data and not saved in the GPU, wherein the third input data is a second batch of data to be processed of the input data.

16. The apparatus of claim 15, wherein the apparatus further comprises an embedding prefetch unit configured to:
record information about the embedding vectors saved in the GPU by a prefetch management queue; and
update information about the prefetched second embedding vectors corresponding to the second input data to the information recorded by the prefetch management queue.

17. The apparatus of claim 15, wherein the embedding update unit is configured to:
train the model based on the second embedding vectors corresponding to the current batch of data of the input data by the GPU to obtain the updated embedding vectors; and
delete information about embedding vectors that are not required for the first input data from the GPU.

18. The apparatus of claim 17, wherein the embedding update unit is configured to:
check embedding vectors corresponding to each batch of data of the first input data and count a frequency of occurrence of each embedding vector among all the embedding vectors corresponding to each batch of data of the first input data;
in response to the training of the model having been completed based on the second embedding vectors corresponding to the current batch of data of the input data, subtract a frequency of occurrence of each embedding vector corresponding to the current batch of data from the counted frequency of occurrence of each embedding vector, correspondingly; and
delete, from the GPU, an embedding vector whose frequency of occurrence is subtracted to 0.

19. The apparatus of claim 18, wherein the embedding update unit is configured to:
delete information about the embedding vector whose frequency of occurrence is subtracted to 0 from information recorded by a prefetch management queue.

20-24. (canceled)

25. An electronic device, comprising:
at least one processor; and
at least one memory configured to store computer-executable instructions, the computer-executable instructions, in response to being run by the at least one processor, is configured to cause the at least one processor to,
acquire input data;
look up embedding vectors corresponding to the input data from an embedding table of a model stored in a memory semantic solid state drive (MS SSD);
transfer the embedding vectors acquired from the MS SSD to a graphics processing unit (GPU); and
instruct the GPU to transfer updated embedding vectors to the MS SSD for updating the embedding table, the updated embedding vectors acquired by training the model based on the embedding vectors transferred to the GPU.

26-28. (canceled)
